(19) United States
(12) Patent Application Publication
(10) Pub. No.: US 2010/0220413 A1
(43) Pub. Date: Sep. 2, 2010

(54) SLIDER SUPPORT MECHANISM, SPRING FORCE CONTROL METHOD AND SPRING FORCE CONTROLLER

(75) Inventor: Atsuo MAKINO, Kawasaki (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/753,674

(22) Filed: Apr. 2, 2010

Related U.S. Application Data
(63) Continuation of application No. PCT/JP2007/069233, filed on Oct. 2, 2007.

(51) Int. Cl. G11B 5/48

(52) U.S. Cl. 360/244.8; G9B/5.147

(57) ABSTRACT

According to one embodiment, a slider support mechanism includes a flexure includes a distal end portion on a front side mounted with a slider includes a magnetic head configured to record/reproduce data on/from a recording medium, a hinge plate configured to produce spring force urging the slider toward the recording medium, a load beam joined to a front portion of the hinge plate, and a base plate joined to a rear portion of the hinge plate. The flexure comprises a front portion on a back side joined to the load beam, a rear portion on the back side joined to at least one of the rear portion of the hinge plate and the base plate, and a control mechanism configured to control the spring force.

### CROSS-REFERENCE TO RELATED APPLICATIONS

This is a Continuation Application of PCT Application No. PCT/JP2007/069233, filed Oct. 2, 2007, which was published under PCT Article 21(2) in Japanese.

### BACKGROUND

1. Field

One embodiment of the present invention relates to a slider support mechanism, a spring force control method, and a spring force controller in a magnetic disk device.

2. Description of the Related Art

A magnetic disk device configured to record/reproduce data is provided with a magnetic disk, and a magnetic head used to access the magnetic disk. The magnetic head is provided on a slider, and the slider is supported by a slider support mechanism.

The slider is caused to fly above the magnetic disk by the balance between the upthrust of an airflow produced by the recording medium (magnetic disk) rotating at high speed, and the spring force imparted by the slider support mechanism toward the recording medium with a minute gap maintained between the slider and the recording medium, and records/reproduces data on/from the magnetic disk.

In recent years, demand for high-density recording in the magnetic disk device has intensified, and stabilization of the slider flying height is desired. However, in the floating magnetic head device described above, the spring force imparted by the slider support mechanism toward the recording medium is constant, whereas the upthrust due to the airflow produced by the rotation of the magnetic disk is determined by the relative speed between the magnetic disk and the magnetic head. The slider moves radially over the magnetic disk, and hence the upthrust is higher at the outer periphery than at the inner periphery. Accordingly, the slider flying height to be determined by the balance between the upthrust and spring force is larger at the outer periphery of the magnetic disk than at the inner periphery, this being a factor in the destabilization of the slider flying height.

Jpn. Pat. Appln. KOKAI Publication No. 5-282821 discloses magnetic head device, as a conventional example of a magnetic head device provided with a slider support mechanism capable of stabilizing the slider flying height. In the magnetic head device, a slider is attached to a suspension, and is further attached to an actuator. Further, a bimetal is arranged on the suspension, a heating coil or the like (not shown) is arranged around the bimetal, the heating coil is connected to a controller, the bimetal is controlled by the controller, the apparent stiffness of the suspension is changed, further the suspension load which is the force resulting from the springiness of the suspension is changed, whereby the downward force (spring force) can be adjusted. As described above, even when the upthrust due to the airflow produced by the rotation of the magnetic disk is changed, it is possible to control the spring force in such a manner that the slider flying height is constant by controlling heating of the bimetal.

However, the bimetal has a characteristic in which the temperature change and displacement are nonlinear with respect to time, and hence there is a problem that the temperature control and displacement control of the bimetal is very difficult. Further, a certain length of time is required to heat the bimetal to a predetermined temperature, and cause desired displacement, and hence there is further a problem that immediate adjustment is difficult, and the responsiveness is poor. Furthermore, so long as the configuration is so made as to cause displacement by heating, there is the possibility of the temperature drift caused by heat arising in the other constituent elements of the support mechanism or in the recording/reproduction characteristics or the like of the magnetic head, and hence it is very difficult to control temperature and displacement after taking full account of these influences.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1A is an exemplary plane view of a slider support mechanism according to an embodiment of the present invention;

FIG. 1B is an exemplary side view of the slider support mechanism;

FIG. 1C is an exemplary bottom view of the slider support mechanism;

FIGS. 2A and 2B are exemplary plane view and exemplary side view each showing a control mechanism of the slider support mechanism according to the embodiment of the present invention;

FIG. 3 is an exemplary schematic view showing a state where the control mechanism of the slider support mechanism according to the embodiment is fixed to a flexure;

FIGS. 4A and 4B are exemplary plane view and exemplary side view each showing another example of a control mechanism of the slider support mechanism according to the embodiment;

FIG. 5 is an explanatory side view for explaining a function of the control mechanism of the slider support mechanism according to the embodiment of the present invention;

FIGS. 6A, 6B, 6C, and 6D are explanatory views for explaining a spring force control function by the slider support mechanism according to the embodiment;

FIG. 7 is an exemplary voltage-displacement characteristic graph of BioMetal (registered trademark) Fiber constituting the slider support mechanism according to the embodiment of the present invention;

FIG. 8 is an exemplary spring force-flying height variation characteristic graph of the slider support mechanism according to the embodiment;

FIG. 9 is an exemplary schematic view showing an example of a control mechanism of a slider support mechanism according to a second embodiment of the present invention; and

FIG. 10 is an exemplary flowchart of a spring force control method according to the embodiment of the present invention.

### DETAILED DESCRIPTION

Various embodiments according to the invention will be described hereinafter with reference to the accompanying drawings. In general, according to an aspect of the invention, there is provided a slider support mechanism comprising a flexure comprising a distal end portion on a front side mounted with a slider comprising a magnetic head configured to record/reproduce data on/from a recording medium; a hinge plate configured to produce spring force urging the slider toward the recording medium; a load beam joined to a front portion of the hinge plate; and a base plate joined to a rear portion of the hinge plate, the flexure comprising a front portion on a back side joined to the load beam, a rear portion on the back side joined to at least one of the rear portion of the hinge plate and the base plate, and a control mechanism configured to control the spring force.

It is possible to realize the configuration to control the spring force of the hinge plate by providing the control mechanism on the flexure without providing the control mechanism directly on the hinge plate configured to produce the spring force. It is possible to control the spring force, whereby it is possible to finely adjust the slider flying height and, as a result of this, it is possible to stabilize the flying height.

According to another aspect of the invention, there is provided a spring force control method of variably controlling a spring force in the slider support mechanism, the method comprising recording/reproducing data on/from a recording medium by means of a magnetic head of the slider; detecting, when an error occurs during recording/reproduction, the occurrence of the error; and applying, at the time of the occurrence of the error, a predetermined voltage to the BioMetal Fiber.

According to the method, it is possible, if a recording/reproduction error occurs during recording/reproduction on/from the recording medium by the magnetic head, to feed the error back, and control the spring force so that an appropriate flying height is obtained.

According to still another aspect of the invention, there is provided a spring force controller configured to variably control spring force of a slider support mechanism comprising a hinge plate configured to produce spring force urging a slider comprising a magnetic head configured to record/reproduce data on/from a recording medium toward the recording medium, the spring force controller comprising a metallic plate; a spacer on the metallic plate; a linear BioMetal Fiber on the spacer; and a resin coating material configured to coat the spacer and BioMetal Fiber, a front end portion and a rear end portion of the BioMetal Fiber being directly or indirectly fixed to the metallic plate.

The configuration that can be singly used as a spring force controller is provided and, not only the configuration in which the spring force controller is fixed to the flexure, but also the configuration in which the spring force controller is fixed to the hinge plate or the like is possible.

Embodiments of the present invention will be described in detail with reference to the drawings.

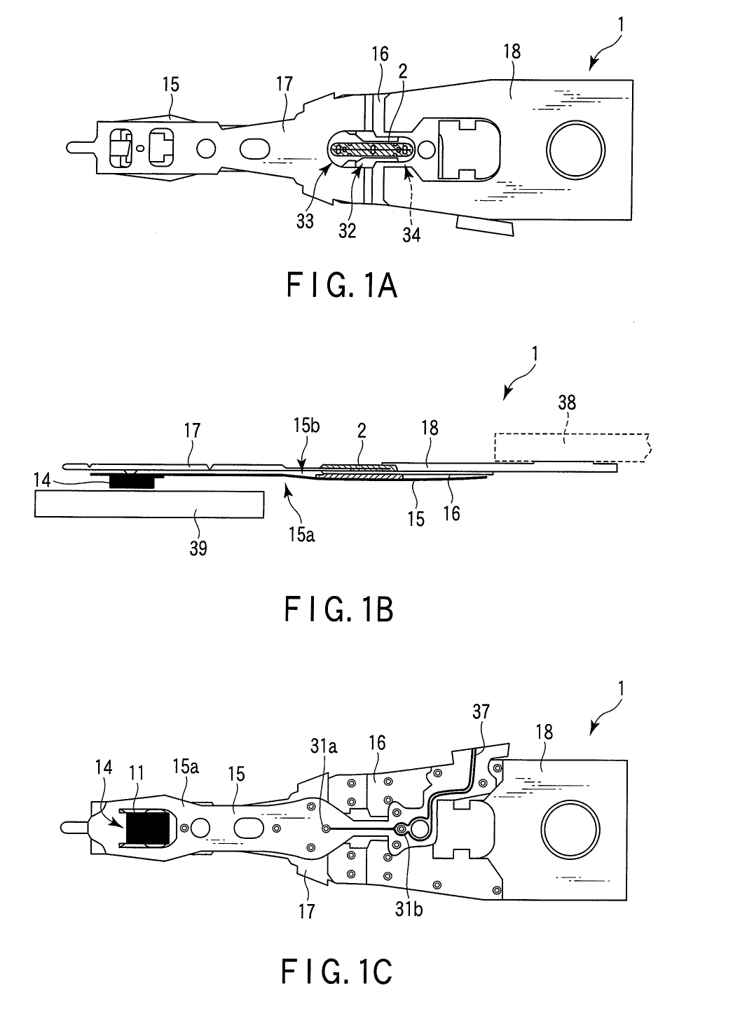

First, the configuration of a slider support mechanism 1 according to a first embodiment of the present invention will be described with reference to FIGS. 1A to 1C.

In the slider support mechanism 1, a base plate 18 is joined to a distal end of an arm 38, a hinge plate 16 is joined to a distal end of the base plate 18, and a load beam 17 is joined to a distal end of the hinge plate 16.

A back 15b side (surface side not opposed to a recording medium 39) of a front portion of a flexure 15 is joined to the load beam 17, and a rear portion of the back 15b is joined to at least one of a rear portion of the hinge plate 16 and base plate 18. A slider 14 on which a magnetic head 11 configured to record/reproduce data on/from a recording medium 39 is mounted is fixed to the front 15a side (surface side opposed to the recording medium) of a distal end portion of the flexure 15.

It should be noted that the above-mentioned joints are formed by, for example, laser welding.

The hinge plate 16 is configured to produce a spring force urging the load beam 17 joined to a front portion thereof toward the recording medium 39 to thereby urge the flexure 15 joined to the load beam 17 toward the recording medium 39, and produce a spring force urging the slider 14 joined to the flexure 15 toward the recording medium 39.

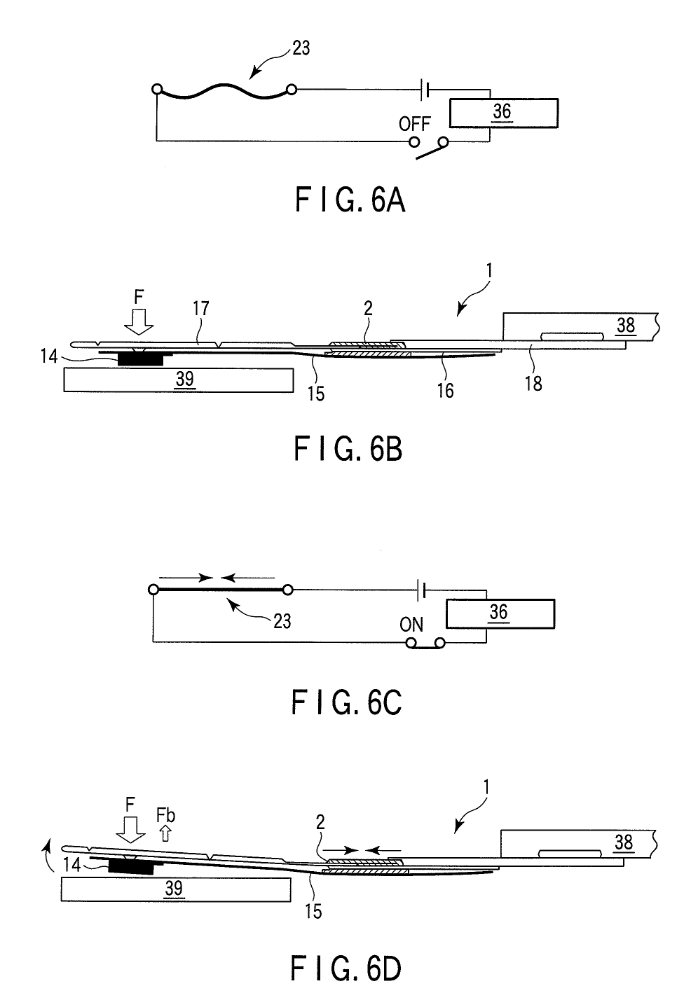

By means of the configuration described above, the slider 14 is caused to fly above the recording medium (magnetic disk) 39 by the balance between the upthrust of an airflow produced by the recording medium 39 rotating at high speed, and spring force F (FIG. 6B) imparted by the hinge plate 16 toward the recording medium 39 with a minute gap (0.1 to 0.2 μm) maintained between the slider and the recording medium, and records/reproduces data on/from the magnetic disk.

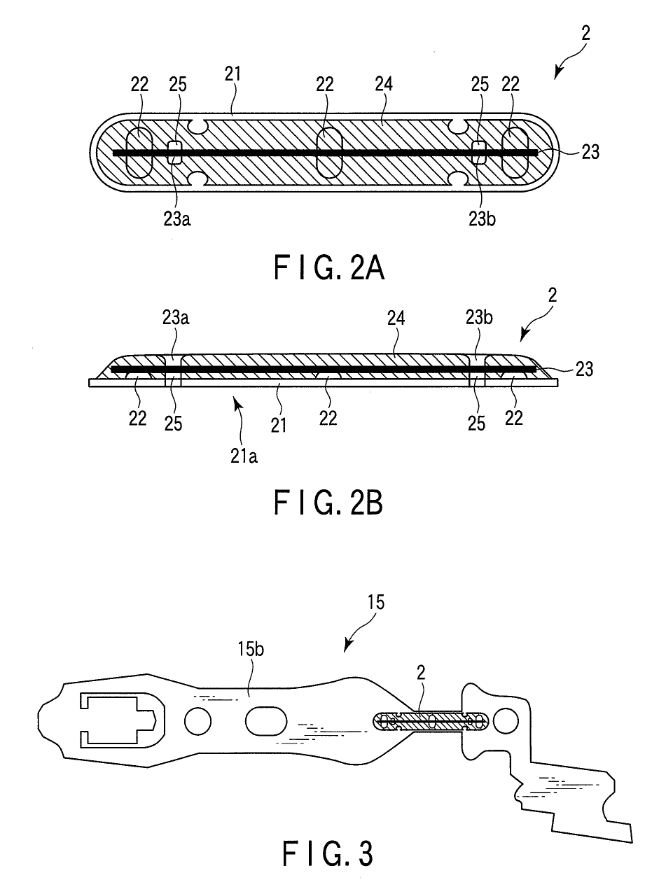

As a first embodiment, a control mechanism 2 configured to control the spring force F is provided on the back 15b side of the flexure 15. The embodiment of the control mechanism 2 is shown in FIGS. 2A (plan view) and 2B (front view).

In the control mechanism 2, a spacer 22 is provided on a metallic plate 21, and a linear BioMetal (registered trademark) Fiber 23 is provided on the spacer 22. In this embodiment, one Fiber 23 is arranged in an I-form. The metallic plate 21 is formed of, e.g., a stainless-steel alloy into a thin plate-shape.

Furthermore, the spacer 22 and BioMetal (registered trademark) Fiber 23 are coated with a resin coating material 24 on the metallic plate 21. As an example, both the spacer 22 and resin coating material 24 are formed by using a polyimide resin.

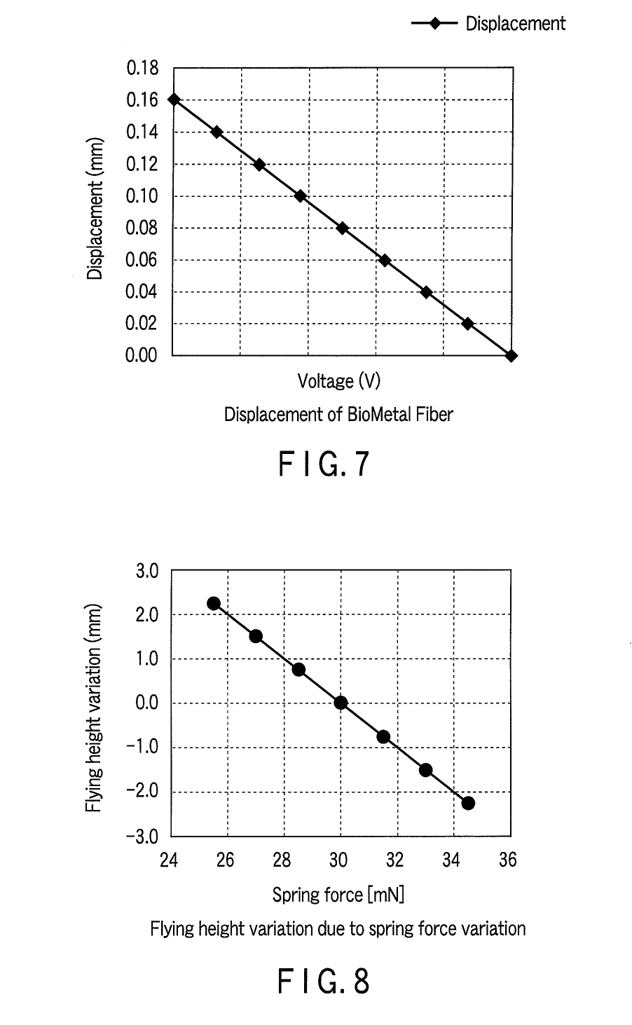

The BioMetal (registered trademark) Fiber is a material provided with a characteristic that when no current flows therethrough, the Fiber is flexible and supple as a nylon thread, and when a current flows therethrough, the Fiber 23 becomes hard as a piano wire to contract. The characteristic is shown in FIG. 7. The BioMetal Fiber 23 has characteristics in addition to that the displacement of the Fiber for the applied voltage has the linearity as shown in FIG. 7, that the Fiber can be driven by a low voltage, is excellent in responsiveness, exhibits narrow temperature hysteresis, and can effect minute motion with a high degree of resolution. The contractile force produced is proportional to the cross-sectional area.

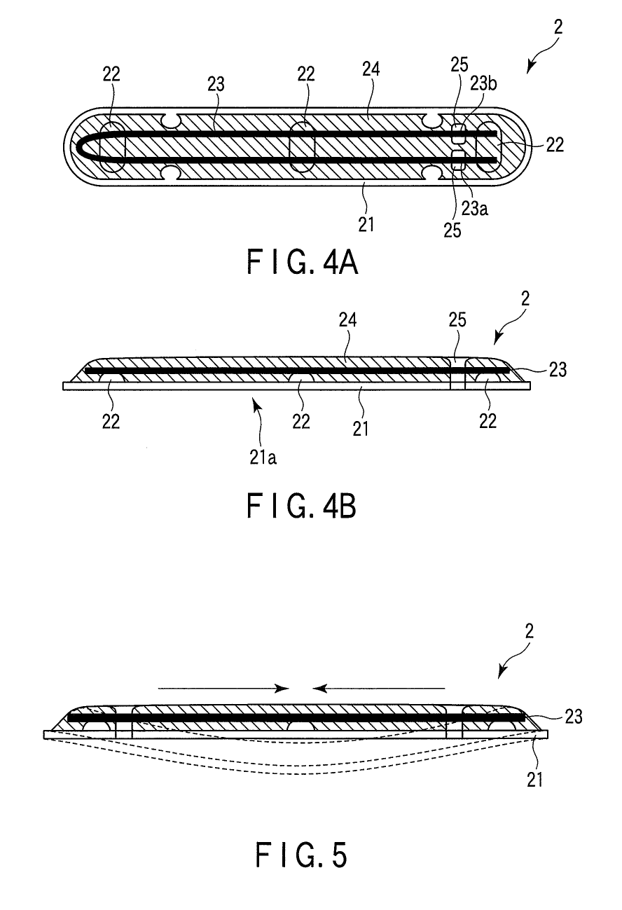

Accordingly, the configuration in which a plurality of BioMetal (registered trademark) Fibers 23 (hereinafter referred to simply as a “Fiber 23”) are arranged in accordance with the required contractile force may be employed. It is conceivable that the Fiber 23 may be formed into an I-, U- or S-shape, or a series of repetitions of the above shape, as a variation of the above configuration. Here, another example (example of U-shaped arrangement) is shown in FIGS. 4A (plan view) and 4B (front view). The example will provide an effective means for a case where when the configuration is formed by using one Fiber, the fiber diameter becomes large, and the control mechanism itself becomes thick, or the like.

Terminal sections 23a and 23b are provided on the Fiber 23 so that the Fiber 23 is enable electrical energization. In order to apply the contractile force of the Fiber 23 to the metallic plate 21 to bend it at the time of energization (FIG. 5), the front end portion and rear end portion of the Fiber 23 are directly or indirectly fixed to the metallic plate 21. A configuration wherein the curvature of the metallic plate 21 is flattened by the Fiber 23 may be also conceivable.

As an example, the control mechanism 2 comprises connection holes 25 penetrating the metallic plate 21 and resin coating material 24 to extend from the underside 21a of the metallic plate to the Fiber 23, and the connection holes 25 are filled with solder, whereby the Fiber 23 is directly fixed to the metallic plate 21. As another example, the Fiber 23 is fixed to the spacer 22 (or resin coating material 24), and the spacer 22 (or resin coating material 24) is fixed to the metallic plate 21, thereby indirectly fixing the Fiber 23 to the metallic plate 21e.

The control mechanism 2 provided with the above configuration can be singly used as a spring force controller. Accordingly, not only the spring force controller is fixed to the flexure 15, but also the spring force controller may be fixed to the hinge plate 16 or the like.

The flexure 15 comprises supply terminals 31a and 31b configured to supply the Fiber 23 with power at positions corresponding to the connection holes 25, and the terminal sections 23a and 23b of the Fiber 23 and supply terminals 31a and 31b are electrically connected to each other by a solder filled into the connection holes 25. A reference symbol 37 in FIG. 1C denotes wiring configured to supply the power.

Fixing of the control mechanism 2 to the flexure 15 is achieved by, for example, laser welding the metallic plate 21 to the flexure 15. At this time, it is necessary for the control mechanism 2 to be fixed to the flexure 15 in such a manner that the longitudinal direction of the Fiber 23 is coincident with the longitudinal direction of the flexure 15. It should be noted that FIG. 3 shows the state where the control mechanism 2 is fixed to the flexure 15.

The function and advantage of the control mechanism 2 provided with the above configuration will be described with reference to FIGS. 6A to 6D.

FIG. 6A schematically represents the state of the Fiber 23 when it is not electrically energized. As described previously, the Fiber 23 is in a flexible and supple state, no contractile force is produced. In this case, in the slider support mechanism 1, the slider 14 flying above the recording medium 39 rotating at high speed is urged toward the recording medium 39 by the spring force F by means of the hinge plate 16 as shown in FIG. 6B.

FIG. 6C schematically represents the state where a voltage is applied to the Fiber 23 to cause a current to flow through the Fiber 23. In response to the electrical energization, the Fiber 23 contracts. As a result, the control mechanism 2 is bent as shown in FIG. 5. At this time, the metallic plate 21 and Fiber 23 are separated from each other by the spacer 22, thus it is possible to produce a large bending moment, and hence to make the cross-sectional area of the Fiber 23 small, this being effective in that the material cost can be reduced, and the thickness of the control mechanism can be prevented from increasing.

The control mechanism 2 is bent, whereby force is applied to the slider support mechanism 1 in the direction in which the flexure 15 is separated from the recording medium 39 as shown in FIG. 6D. That is, force Fb acts in the direction opposite to the direction of action of the spring force F.

As described above, by controlling the voltage to be applied to the Fiber 23, it is possible to control force Fb, and an advantage of being able to adjust the spring force F by control of force Fb is obtained. That is, by adjusting the spring force F, it is possible to adjust the slider flying height. Here, the flying height variation obtained when the spring force is controlled is shown in FIG. 8. The flying height variation implies a value indicating the variation of the slider flying height by regarding the direction in which the magnetic head moves away from the recording medium 39 as the positive direction.

Particularly, by configuring the control mechanism to include the Fiber 23, and by controlling the voltage, it is possible to greatly improve the responsiveness as compared with the prior art technique. As a result of this, at the time of execution of recording/reproduction, even when an inevitable need for fine adjustment of the slider flying height arises because of, for example, an error, a remarkable advantage of being able to immediately adjust the flying height appropriately is obtained. Further, the adjustment is achieved by voltage control, and hence an advantage of being free from an adverse influence of temperature control is further obtained.

It should be noted that the fine adjustment of the slider flying height is not limited to an unexpected case such as occurrence of an error, and in order to stabilize the flying height by eliminating the difference between the inner periphery and outer periphery of the magnetic disk in relative speed, it is also possible to control the spring force to a predetermined magnitude in accordance with the position on the magnetic disk.

Further, the control mechanism 2 obtains an advantage of preventing an imbalance in displacement between the left side of a center line in the longitudinal direction, and right side thereof by being provided with the configuration in which the control mechanism 2 is fixed to the back 15b of the flexure 15 at the central portion thereof in the width direction.

Furthermore, it is also the characteristic point of this embodiment that the control mechanism 2 is configured in such a manner that the mechanism 2 is not arranged on the hinge plate that directly produces spring force, but is provided on the flexure 15, and the mechanism 2 is not brought into direct contact with the hinge plate 16, load beam 17, and base plate 18. That is, in this embodiment, as shown in FIGS. 1A and 1C, the slider support mechanism is configured in such a manner that a hole portion 32 is provided in the central portion of the hinge plate 16, further cutout portions 33 and 34 are formed in the rear portion of the load beam 17, and in front portion of the base plate 18, respectively, and the control mechanism to be fixed to the flexure 15 is arranged in the hole portion 32, and cutout portions 33 and 34, whereby it is possible to configure the support mechanism 1 so that the thickness of the support mechanism 1 can be kept very small. It should be noted that when the control mechanism 2 is formed into such a shape that the mechanism 2 does not come into contact with the rear portion of the load beam 17, and front portion of the base plate 18, the cutout portions 33 and 34 need not be provided.

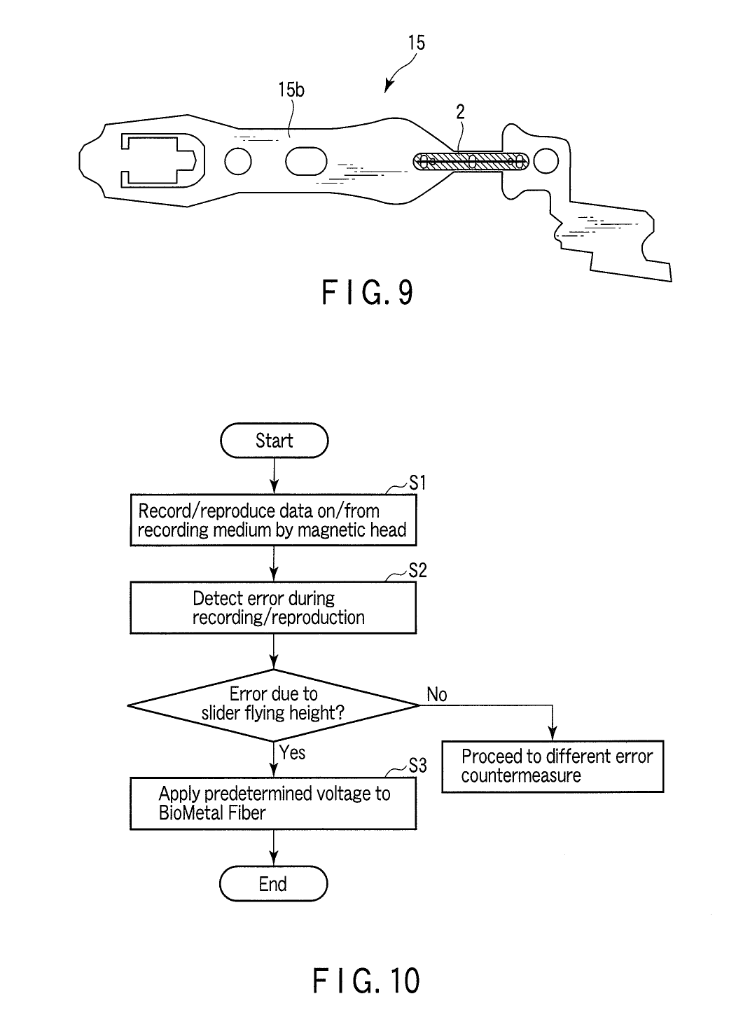

Subsequently, a second embodiment of a control mechanism 2 is shown in FIG. 9. Unlike the first embodiment, after the control mechanism 2 is configured on a metallic plate 21, the control mechanism 2 is configured in such a manner that the mechanism 2 is not fixed to a flexure 15, and is directly formed on the flexure 15.

More specifically, regarding the control mechanism 2, a spacer 22 is provided on the flexure 15, and the Fiber 23 is provided on the spacer 22. At this time, the Fiber 23 is configured to be arranged in the longitudinal direction of the flexure 15. Furthermore, the spacer 22 and Fiber 23 are covered with a resin coating material 24. It should be noted that as an example, the flexure 15 is formed into a thin plate-like shape by using a stainless-steel alloy, and both the spacer 22 and resin coating material 24 are formed by using a polyimide resin.

Furthermore, a front end portion and rear end portion of the Fiber 23 are directly or indirectly fixed to the flexure 15. As an example, connection holes 25 provided to penetrate the flexure 15 and resin coating material 24 and extend from a front 15a of the flexure 15 to the Fiber 23 are filled with solder, whereby the Fiber 23 is directly fixed to the flexure 15, and is electrically connected to the flexure 15. By this configuration, a remarkable advantage of simultaneously realizing the mechanical connection and electrical connection is obtained.

Further, it is possible to omit the configuration in which the metallic plate 21 is welded to the flexure 15, and hence it is also possible to reduce both the material cost and process cost.

It should be noted that as a modification example, the configuration in which a plurality of Fibers 23 are arranged in accordance with the required contractile force may be employed, and it is also conceivable that the Fiber 23 is formed into an I-, U- or S-shape, or a series of repetitions of the above shape. The above configuration will provide an effective means for a case where when the configuration is formed by using one Fiber, the fiber diameter becomes large, and the control mechanism itself becomes thick, or the like.

Subsequently, a spring force control method according to the embodiment of the present invention to be carried out by using the slider support mechanism 1 configured as described above will be described. FIG. 10 shows a flowchart of the method.

Block 1 of recording/reproducing data on/from the recording medium 39 is executed by the magnetic head 11 of the slider 14. At this time, the spring force F initialized in advance at the hinge plate 16 acts on the slider 14 (FIG. 6B).

If an error occurs during recording/reproduction, block 2 of detecting the error is executed. Block 2 is executed by an operation processing section (not shown), and the cause of the error is verified. If it is determined that the error is due to the slider flying height, a spring force control signal set to adjust the slider flying height appropriately and eliminate the error is transmitted to a voltage control section 36.

Next block 3 is a step in which the voltage control section 36 applies a predetermined voltage to the Fiber 23 in accordance with the spring force control signal. In the Fiber 23 to which the voltage is applied, contractile force corresponding to the voltage is produced and, as a result of this, control spring force Fb acts on the spring force F, whereby it is possible to make optimal spring force (F-Fb) act on the slider 14 (FIG. 6D). In this way, the slider flying height is appropriately adjusted, and an error is eliminated.

According to the spring force control method described above, it is possible, if a recording/reproduction error occurs because of, for example, temperature drift during recording/reproduction on/from the recording medium 39 by the magnetic head 11, to feed the error back and control the spring force so that an appropriate flying height is obtained. As described above, this method provides excellent responsiveness, and hence is particularly effective when used during execution of recording/reproduction.

As has been described above, according to the present embodiment, it is possible to control spring force in a state where low-voltage drive is enabled, with excellent responsiveness, narrow temperature hysteresis, and high resolution, whereby it is possible to finely adjust the slider flying height. As a result of this, it is possible to adjust the slider flying height appropriately with a high degree of responsiveness, and stabilize the flying height.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A slider support device comprising:
a flexure comprising a distal end portion on a front side with a slider comprising a magnetic head configured to record data on a recording medium and to reproduce data from the recording medium;
a hinge plate configured to produce spring force pressing the slider toward the recording medium;
a load beam attached to a front portion of the hinge plate; and
a base plate attached to a rear portion of the hinge plate,
the flexure comprising a front portion on a back side attached to the load beam, a rear portion on the back side attached to at least one of the rear portion of the hinge plate and the base plate, and a controller configured to control the spring force.

2. The slider support device of claim 1, wherein the controller comprises a metallic plate, a spacer on the metallic plate, a linear BioMetal Fiber on the spacer, and a resin coating material configured to coat the spacer and BioMetal Fiber which is a fiber-like actuator configured to contract and extend like muscles,
wherein a front end portion and rear end portion of the BioMetal Fiber are directly or indirectly attached to the metallic plate, and
the controller is attached to the flexure in such a manner that a longitudinal direction of the BioMetal Fiber is along with a longitudinal direction of the flexure.

3. The slider support device of claim 2, wherein the controller comprises a connection hole through the metallic plate and the resin coating material extending from a back side the metallic plate to the BioMetal Fiber,
the flexure comprises a supply terminal configured to supply the BioMetal Fiber with power at a position corresponding to the connection hole, and
the connection hole comprises solder, and the BioMetl Fiber and supply terminal are connected to each other by the solder.

4. The slider support device of claim 1, wherein the controller comprises one or a plurality of BioMetal Fibers arranged in the longitudinal direction of the flexure with a front end portion and a rear end portion of each BioMetal Fiber attached to the flexure.

5. The slider support device of claim 4, wherein in the controller comprises a spacer on the flexure,
the BioMetal Fiber is on the spacer,
the spacer and BioMetal Fiber are coated with a resin coating material,
a front end portion and a rear end portion of the BioMetal Fiber are directly or indirectly attached to the flexure, and
the controller comprises a connection hole through the flexure and resin coating material and extending from a back side of the flexure to the BioMetal Fiber,
the connection hole comprises solder, and the BioMetal Fiber and the flexure are connected to each other by the solder.

6. The slider support device of claim 2, wherein the controller is attached to the back of the flexure at a central portion of the flexure in a width direction of the flexure, and
at least the hinge plate, among the hinge plate, load beam, and base plate, comprises a hole portion or a cutout portion configured to prevent the hinge plate from being in contact with the controller.

7. The slider support mechanism of claim 2, wherein the BioMetal Fiber is in an I-shape, U-shape, S-shape or a shape of a series of repetitions of the shape.

8. A spring force control method of variably controlling a spring force in the slider support device of claim 1, the method comprising:
recording data on a recoding medium and reproducing data from the recording medium through a magnetic head of the slider;
detecting an error when the error occurs during recording and reproduction; and
applying a predetermined voltage to the BioMetal Fiber when the error is detected.

9. A spring force controller configured to variably control spring force of a slider support device comprising a hinge plate configured to produce spring force pressing a slider toward the recording medium, the slider comprising a magnetic head configured to record data on a recording medium and to reproduce data from the recording medium, the spring force controller comprising:
a metallic plate;
a spacer on the metallic plate;
a linear BioMetal Fiber on the spacer; and
a resin coating material configured to coat the spacer and BioMetal Fiber,
a front end portion and a rear end portion of the BioMetal Fiber being directly or indirectly attached to the metallic plate.

10. The spring force controller of claim 9, wherein the BioMetal Fiber is in an I-shape, U-shape, S-shape or a shape of a series of repetitions of the shape.
